(19) United States
(12) Patent Application Publication
(10) Pub. No.: US 2007/0038652 A1
(43) Pub. Date: Feb. 15, 2007

(54) Data driven cultural customization

(75) Inventors: Yaniv Feinberg, Redmond, WA (US); Ayman M. Aldahleh, Redmond, WA (US); Makarand A. Gadre, Redmond, WA (US); Lev Lioznov, Bellevue, WA (US); Kiran Akella Venkata, Redmond, WA (US)

Correspondence Address: MICROSOFT CORPORATION;ATTN: PATENT GROUP DOCKETING DEPARTMENT, ONE MICROSOFT WAY, REDMOND, WA, 98052-6399, US

(73) Assignee: Microsoft Corporation, Redmond, WA (US)

(21) Appl. No.: 11/205,469

(22) Filed: Aug. 15, 2005

(51) Int. Cl. G06F 7/00

(52) U.S. Cl. 707/100

(57) ABSTRACT

A system and method for modifying a cultural database that is used by a computer application to drive culture-specific and language-specific functional aspects of the program. After defining a set of cultural parameters for program behavior and storing the parameters in a database, support for new cultures or languages, or modification and maintenance of existing cultures or languages, may be done through adding or manipulating data in the database.

### BACKGROUND

a. Technical Field

The present invention pertains generally to computer programs that are used across several cultures and specifically to modification and maintenance of such programs for existing or additional cultural support.

b. Description of the Background

Many software programs are used in different locations throughout the world. Programmers often must accommodate diverse cultural and language variations as they develop the software. These cultural and language differences can add significant complexity to the software, and require substantial changes to the software when a new language is supported.

Language and culture drive certain behavior in many different programs. In addition to the text strings, language and cultural considerations can affect many other aspects of a program, and specifically functional aspects of the program. These functional aspects of a program have generally been ‘hard coded’ into the source code and been notoriously difficult to update and change. Adding support for a new language or culture can be especially difficult when the program has many culture-specific functions.

It would therefore be advantageous to provide a system and method for maintaining and adding cultural support for computer applications deployed in several different cultures.

### SUMMARY

Culturally-neutral computer applications can be adapted for new cultures or languages through the modification of a database of cultural parameters. The parameters relate to functional aspects of the computer applications that are coded into executable programs that query the database to determine the proper function to execute. The database may contain parameter values for each supported culture or language. In order to support a new language or culture, modifications can be made to the database by linguistic or cultural experts without requiring modification to executable code by a programmer.

### BRIEF DESCRIPTION OF THE DRAWINGS

In the drawings,

FIG. 1 is a diagrammatic illustration of an embodiment showing a system for common cultural operations.

FIG. 2 is a diagrammatic illustration of an embodiment showing program/database interaction.

FIG. 3 is an illustration of an embodiment showing a parameter table.

FIG. 4 is a diagrammatic illustration of an embodiment showing the activities performed by different persons during the development and maintenance of a software application.

FIG. 5 is a flowchart illustration of an embodiment showing a method for developing executable code.

FIG. 6 is a flowchart illustration of an embodiment showing a method for database creation.

### DETAILED DESCRIPTION

While the invention is susceptible to various modifications and alternative forms, specific embodiments of the invention are shown by way of example in the drawings and will herein be described in detail. It should be understood, however, that there is no intent to limit the invention to the particular forms disclosed, but on the contrary, the invention is to cover all modifications, equivalents, and alternatives falling within the spirit and scope of the invention as defined by the claims. In general, the embodiments were selected to highlight specific inventive aspects or features of the invention.

Throughout this specification, like reference numbers signify the same elements throughout the description of the figures.

When elements are referred to as being “connected” or “coupled,” the elements can be directly connected or coupled together or one or more intervening elements may also be present. In contrast, when elements are referred to as being “directly connected” or “directly coupled,” there are no intervening elements present.

The invention may be embodied as devices, systems, methods, and/or computer program products. Accordingly, some or all of the invention may be embodied in hardware and/or in software (including firmware, resident software, micro-code, state machines, gate arrays, etc.) Furthermore, the present invention may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. By way of example, and not limitation, computer readable media may comprise computer storage media and communication media.

Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can accessed by an instruction execution system. Note that the computer-usable or computer-readable medium could be paper or another suitable medium upon which the program is printed, as the program can be electronically captured, via, for instance, optical scanning of the paper or other medium, then compiled, interpreted, of otherwise processed in a suitable manner, if necessary, and then stored in a computer memory.

Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

When the invention is embodied in the general context of computer-executable instructions, the embodiment may comprise program modules, executed by one or more systems, computers, or other devices. Generally, program modules include routines, programs, objects, components, data structures, etc. that perform particular tasks or implement particular abstract data types. Typically, the functionality of the program modules may be combined or distributed as desired in various embodiments.

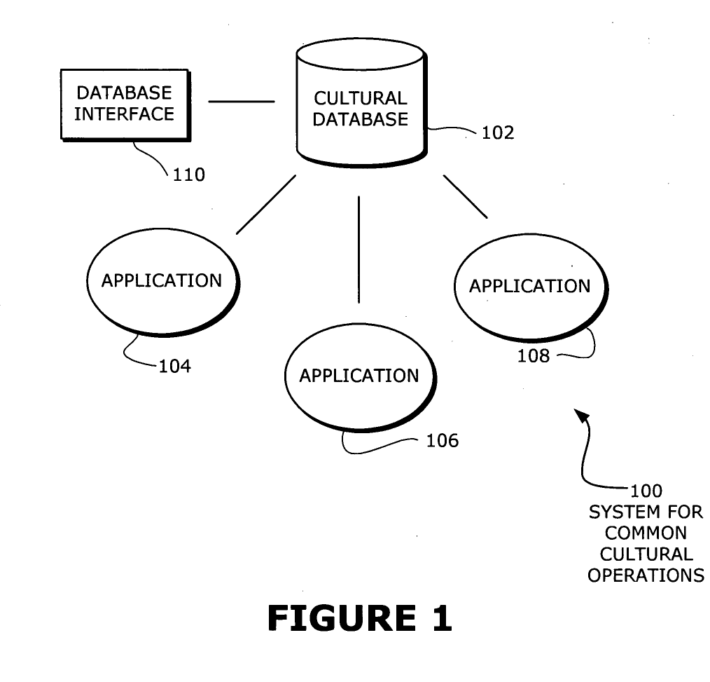

FIG. 1 illustrates an embodiment 100 showing a system for common cultural operations. A cultural database 102 is used by multiple applications 104, 106, and 108. An interface 110 to the database 102 allows for modification and addition to the parameters stored in the database 102.

The embodiment 100 is an architecture for culturally-neutral applications that can be readily adapted and distributed in new geographic locations with a minimum of modification. When an application is written for use in several different countries, there are many different functional aspects of the application that should be adjusted to meet the needs of the local users. These functional aspects are stored in the database 102 to simplify the maintenance of the cultural and language aspects, but also to allow support of new cultures with a little or no modification to the actual executable programs.

For the purposes of this specification, references to functional aspects of cultural or language differences or other similar terms relate to functional, operational, or behavioral aspects of an executable program that change from one culture, language, or region to another. Such aspects include specific cultural or language properties that are used change the behavior of a software routine and affect the process of the routine. For example, functional aspects of cultural or language differences do not include text strings that may be displayed to a user in a specific language, but may include functional parameters describing how such text is displayed.

The present embodiment tends to be useful for situations where a computer program is deployed in many countries, especially the smaller countries with specific language and cultural differences. As the number of supported locations increases, the complexity of computer applications also increases. This is because a programmer may have to include each supported language or culture in each branch of the program that requires different language or cultural functionality. The complexity is felt the most when support for a new country is implemented. In previous technologies, a programmer may have to search through and modify many lines of code in many locations to incorporate a new country's peculiar settings. With the present embodiment, such settings are stored in the database 102 rather than in the executable code.

The cultural database 102 may contain many different functional aspects that define how a computer program application may handle cultural and language peculiarities. These peculiarities may include any type of language, country, or cultural uniqueness that the application may need to handle.

For example, language functional aspects may include the direction of flow, i.e., from left to right or right to left. Languages such as English, Spanish, and Italian flow from left to right. Arabic and Hebrew flow from right to left. When application 106 displays text on a screen, it may reference a direction of flow variable in the cultural database 102.

In another example, a country may have different standards for postal codes. The United States uses an all-numeric postal code of 5 or 9 digits, but Canada uses a combination of alphanumeric characters. The database 102 may contain rules or other functional aspects or definitions of particular postal codes for various countries. These rules or description may be used by the various applications to verify proper postal code format or other functions. A cultural uniqueness may include items such as standard paper and envelope sizes, or may include whether a decimal point is represented by a period or comma. Additional items may include the layout of a computer keyboard, currency symbols, or any other cultural, language, or location-specific item.

The peculiarities can encompass any functional difference between two or more different areas of distribution of the various applications.

The database 102 may be queried using a protocol. Typically, each application 104, 106, and 108 may use the same protocol to access the database 102. In some instances, more than one protocol may be used to access the database 102. Such a protocol may be standardized and distributed for other application developers to use the database 102, or may be a proprietary protocol. Any type of query protocol may be used in a given system, and the selection of the database and query protocol may depend on the type of data stored, the size of the data, speed of access, or other factors.

The database interface 110 may allow modification, browsing, addition, removal, or other changes to the database 102. The database interface 110 may use the same or similar protocol as the applications 104, 106, and 108, or may be a completely different protocol. In some cases, the database 102 may be compiled or optimized into a machine-readable format. In such cases, a human-readable format may be kept in addition to a machine-readable format so that the maintenance of the database 102 could be performed on the human-readable version and re-compiled when changes are implemented.

The applications 104, 106, and 108 may be any type of computer application at all. Applications that are especially suited to the present embodiment include those that have a user interface. Many cultures, languages, and countries may require specific functional differences for the user interfaces. This can include text formatting and display of the native language, but may also include functional differences such as the display of addresses, phone numbers, and other data fields in a peculiar format.

Similarly, some embodiments may handle and process the native language or local data without displaying the data on a user interface. For example, a database management system or data collection system may process and handle data outside the view of the user. However, the local customs may dictate how the data is collected, managed, stored, and compared. In a simple example, incoming numerical data may be captured using a comma for the decimal point in one location while using a period for the decimal point in another location. Similarly, an application that processes addresses may have different routines for verifying postal codes based on the country of origin.

Since all of the applications 104, 106, and 108 use the common database 102, the functional ‘look and feel’ of each application can be unified. In some cases, an entire suite of programs may be created that share the same database 102.

In some cases, the database 102 may be distributed and located on the same system as the applications 104, 106, and 108. In other cases, the database 102 may be located remotely, such as on a local network location or on the Internet at a central location. Similarly, the applications 104, 106, and 108 may run on any configuration possible, including a standalone computer application, remotely hosted application, thick or thin client/server application, or any other distribution and execution configuration.

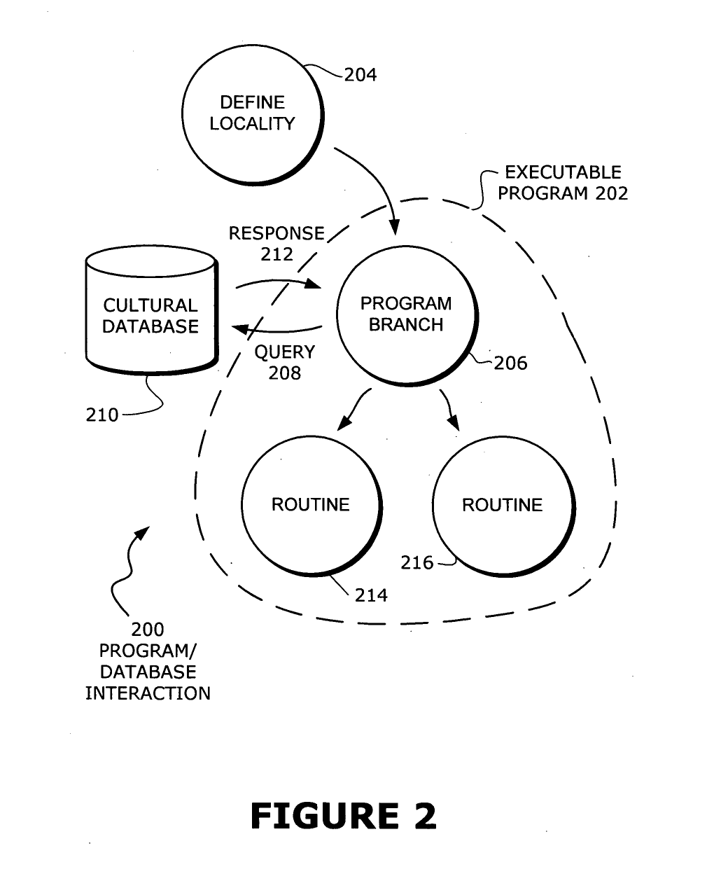

FIG. 2 illustrates an embodiment 200 of a program/database interaction. The executable program 202 uses the locality definition 204 when it encounters a program branch 206. The locality information 204 is used in query 208 to the database 210. The response 212 directs the program 202 to execute one of the routines 214 or 216.

The embodiment 200 uses the location information 204 to query a cultural database 210 to determine a functional operation of the executable program 202. The branch 206 may be any portion of the program 202 that uses a property of a culture or language.

For example, when a text string is to be displayed, a program branch 206 may be created for a right-to-left language routine or a left-to-right language routine. The executable program 202 may query the database 210 to select one or the other routine.

The branch 206 can be placed anywhere that a variable property of a language or culture is used to change the behavior of the executable program 202. The architecture of the program 202 uses cultural and language properties for branching, as opposed to the language or culture itself. In the example above, the property can be defined as language presentation direction. The value for the property can be stored in the database 210 for each different locality 204.

By defining and programming using functional aspects of language or cultural properties, rather than the language or culture itself, the executable code 202 may be made culturally-neutral. When the executable code 202 is culturally-neutral, changes to the culture or language can be made through modifying the database 210 rather than the executable code. Typically, items embedded in executable code are difficult to maintain, and require an experienced programmer to find, change, and test each area of code that is modified. In the embodiment 200, maintenance items may be stored in the database 210 and can be modified and tested without requiring any changes to the executable code.

Another advantage of culturally-neutral programming is that support for new languages, localities, or cultures can be done through modification of the database 210. For example, an early version of an application may be written to support English and Hebrew. In order to deploy the program in Arabic and Spanish, the functional code may be left alone and the database 210 may be modified for entries for Arabic and Spanish. A separate database may include text strings for each language that may be displayed in dialog boxes, commands, etc.

In some embodiments, the cultural differences may include properties of different countries. For example, English may be common to the US, Canada, the UK, and Ireland, each country may have different postal codes, currency symbols, and other properties. Further, there may be properties that are unique to various time zone differences, or unique properties for certain metropolitan areas. In some cases, a particular company or division of a company may have unique requirements such as default paper size, intra-company addresses, or other company or group specific behavior. Certain sub-groups, such as religious sects, fan clubs, participants in an online game, or any other group may establish a cultural identity having a unique set of functional aspect parameters that drive an application's behavior.

Some embodiments may allow a user or administrator to modify and update the database 210 for specific installations. In other embodiments, the database 210 may be modified and maintained by the software developing company, and often by the linguistic or cultural expert at the software company.

The embodiment 200 may be used when data used by an application has a cultural designation. The data's cultural designation may be different from the user's cultural designation. For example, the user may have the default locality set as United States English, but may have an application that is to display Hebrew text. The Hebrew text data may be tagged with a cultural designation for Hebrew. When the Hebrew text is to be displayed, the Hebrew cultural designation may be sent in the query 208 to respond with the Hebrew values for the query, which are used by the application to properly display the Hebrew text.

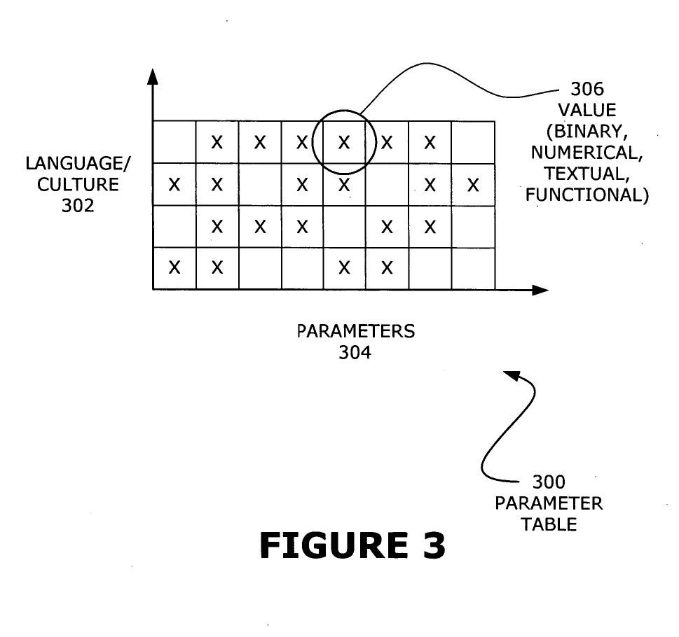

FIG. 3 illustrates and embodiment 300 showing a parameter table. The languages/cultures are positioned on the vertical axis 302 while the parameters are positioned on the horizontal axis 304. In each intersection, a parameter value 306 can be stored. The parameter value 306 may be a binary, numerical, textual, functional, rule, or other description of the value.

The parameter table 300 is one form of a database that can store values for various cultural parameters. The parameter table 300 may take any form for storing and retrieving cultural parameter values. In some cases, the table 300 may be used for, inputting data and may be compiled, translated, optimized, or otherwise changed for use in a computer system.

Each language or culture may be represented by a row in the parameter table 300. The culture may be any location for which localization is desired. This may be individual countries, economic regions, languages, group affiliation, or any other localization desired.

The parameters along the columns of the parameter table 300 may be any functional aspect of a program that may vary with the language or culture. These parameters may include any type of variable that changes from one culture to another, and may be tailored to very specific functional features of the application that uses the parameter table.

The values of the parameters may be any type of data that can be used by the application for customizing the functionality for specific cultures. These data may be binary true/false flags that may indicate left-to-right text presentation when true, for example. Numerical values may be useful for designating the standard length of a postal code string, for example. Text strings may be used to represent the name of a country or region or the currency symbol in the location. In some situations, values may be presented in the form of an n-dimensional array.

Functional values of the parameters may include a description of appropriate formatting for telephone numbers in a location. The functional values may be text strings, XML data or schema, commands to be interpreted by the application, rules to be evaluated, or any other usable description. The functional value may be a single string or may be many lines or even megabytes of data. The values may come in any form and any length.

The specific form of data values may depend on the application. For example, in an address book manager for a mailing program, a sophisticated evaluation of postal codes may be used to verify postal code accuracy and format per postal system specifications. In another application, a postal code may be evaluated more crudely by merely checking that the appropriate number of digits is present. In the first example, the postal system specification for each country may specify proper text size and placement, features which are not necessary in the second example.

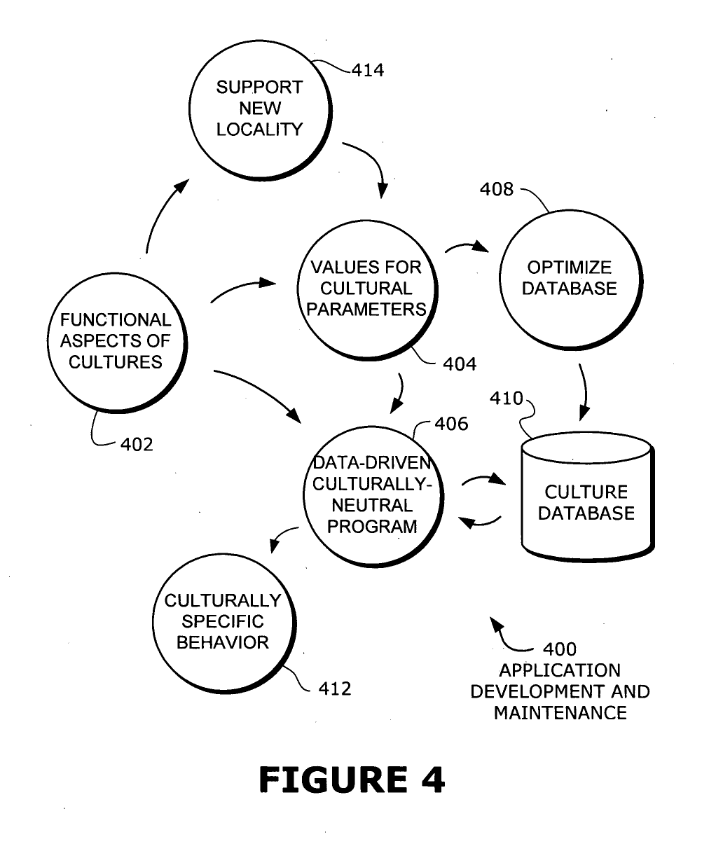

FIG. 4 illustrates an embodiment 400 showing the development and maintenance of a culturally-specific application. The functional aspects of the supported cultures and languages are defined in block 402. Values for the aspects are created in block 404 while a culturally-neutral program is developed in block 406. The parameters and values from block 404 may be optimized in block 408 to produce the database 410. The culturally-neutral program of block 406 may interact with the database 410 to produce culturally specific behavior in block 412. When a new culture is to be supported in block 414, additional values are created for the parameters in block 404, the database is recreated in block 408 to produce functionality that corresponds to the new culture.

The functional aspects of the supported cultures are defined in block 402. These aspects may be created by examining various cultures and identifying features that make the cultures unique. For example, a linguistics expert may identify traits of languages that need to be considered when processing or displaying the languages. Similarly, an expert in international postal codes may define various characteristics of postal codes and postal addresses that are common among groups of countries and characteristics that are unique to specific countries. By creating the cultural properties first, a broad, comprehensive set of parameters may be created that support a very large range of applications and cultures. Such a method may be useful for developing a generalized cultural database that is shared across many applications. However, the database and parameters may be broadly defined and may be refined and expounded as software applications are developed that use the database. Further, not all of the parameters may be used for each specific application, causing the size of the database to be larger than necessary for one specific application.

Another method for developing parameters in block 402 may be to examine the specific functionality of the program of block 406 and define cultural parameters that can be used to direct the specific functionality of the specific application. Such a method may yield a more specific database 410 that is tailored to the application of block 406. In some cases, the database 410 may be so specific that the database 410 cannot be practically shared amongst applications.

Both methods for determining the functional parameters have advantages and disadvantages. The first method may be suited for development of a cultural database that may be shared across many different applications, a suite of applications, or several applications that perform similar functions or handle similar data. Such a database may have a common interface that is used by many different software programmers from many different software companies, or may have a proprietary interface that is used within one company for a unified ‘look and feel’ and common maintenance platform for a suite of applications. The second method may be appropriate for single applications that do not share functionality with other applications, or for deployments where the size and complexity of a broad, comprehensive database creates unwanted storage and retrieval issues.

In some cases, the cultural parameters selected in block 402 may be comprehensive so that when a new culture is supported in block 414, all that is needed is that the values for the new culture are added to the parameters in block 404. In such a case, a new culture can be supported without requiring any changes to the executable code of the program of block 406. When the newly supported culture poses an unforeseen problem with the functionality of the program of block 406, the executable code may need to be modified. Such a problem may occur when the original specification of the application includes support for a very limited number of languages or cultures, but a much different language or culture is required to be supported at a later date.

For example, if the original specification for an application includes support for United States and Western European countries, right-to-left textual support may not be included in the program of block 406. When support is later required for Israel or Arab-speaking countries, a new parameter for right-to-left or left-to-right text presentation may be added to the database 410 and appropriate changes may be made to the program of block 406. If the original specification included support for the Hebrew language, which is a right-to-left language, adding support for Arabic, another right-to-left language, may only require adding values to the parameters that correspond with the Arabic language, and no changes may be required of the executable code.

In some cases, the values for the cultural parameters may be in a human-readable form in block 404 and changed into a machine-readable form by the optimization process of block 408. For example, the parameters and values may be developed and maintained in a text based manner such as XML, an index table manner such as a spreadsheet, or any other manner that for a person to view, modify, and add parameters and values to the database. A human-readable source may be used to generate an optimized and machine readable version of the database 410. When subsequent changes are required of the database, a developer may make changes to the original human-readable source and recreate the database 410. In some embodiments, a developer may have an interface so that modification and maintenance of the database 410 may be done directly.

In some embodiments, the database 410 may be human-readable data that undergoes no optimization from block 408 and can be read, edited, and modified by a developer directly. Such embodiments may include those where the database 410 is comprised of XML data.

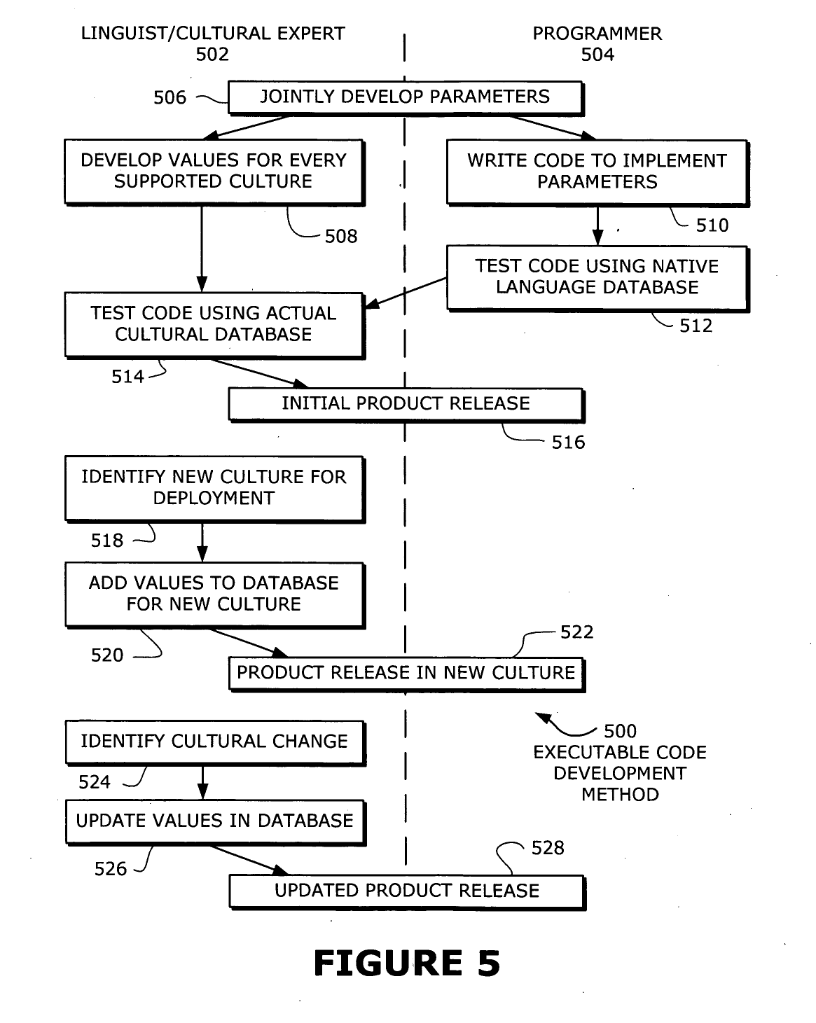

FIG. 5 illustrates an embodiment 500 showing procedures by different parties in developing and maintaining a data-driven program having functional cultural differences. In the left hand column 502 are the activities of a linguist or cultural expert, while in the right hand column 504 are the activities of a programmer. Cultural and linguistic parameters are jointly developed by the two persons in block 506. The cultural expert may develop values for each parameter for every supported culture in block 508, while the programmer writes code to implement the parameters in block 510 and tests the code using his or her native language database in block 512. After the code is debugged in block 512, the cultural expert may test the code using the actual cultural database in block 514. After testing, the product is ready for release in block 516.

When a new culture is identified for deployment in block 518, the cultural expert may add values to the database in block 520 and release the new database to support the new culture in block 522. Similarly, if a cultural change occurs in block 524, the values of the database may be modified in block 526 and the updated database may be released in block 528.

Embodiment 500 illustrates how changes to an application that relate to cultural functional changes may be implemented and released without involving a programmer. A cultural or linguistic expert may be responsible for maintaining a database of functional parameters that can cause an executable program to behave in conformance with specific cultural aspects defined in the database. The cultural or linguistic expert may be someone specifically educated in a language or culture, or may be a user or system administrator for a local implementation of the application. In some cases, a user may customize the application for his or her cultural or language preferences, such as setting the cultural parameters used within one company or within another group of users. Without modifying the executable code, such a user may modify, update, test, and deploy the cultural database for his or her specific locale.

The process by which someone updates and modifies the cultural database may vary with the specific application. For a small database with a few number of parameters, the user may merely edit a text file that contains the database. For larger databases, a custom application may be written for displaying, manipulating, and modifying the data in the database. Each embodiment may any database architecture and interface.

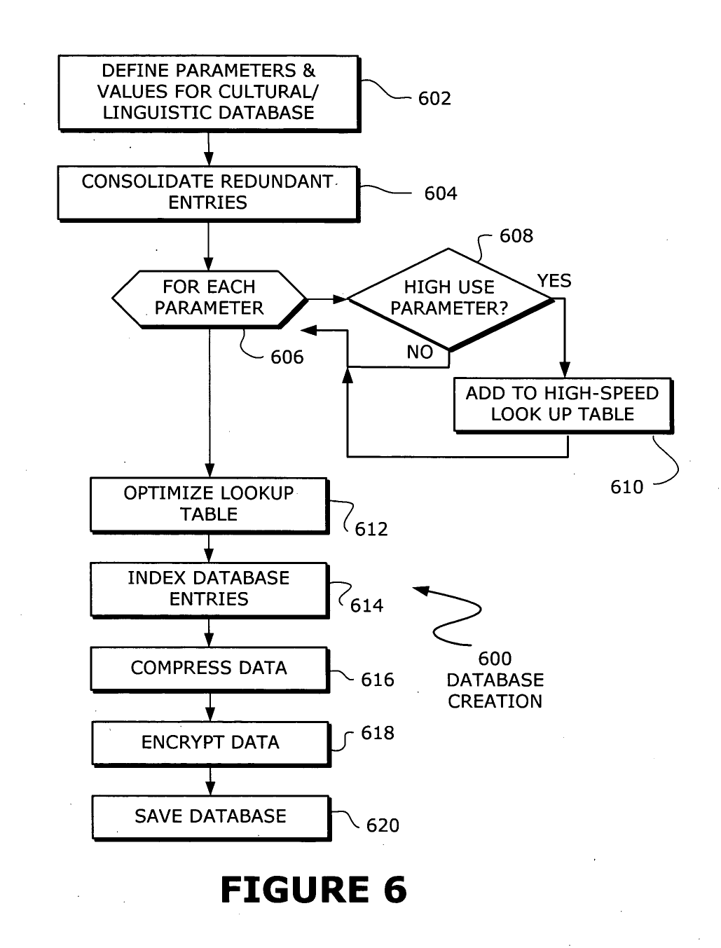

FIG. 6 illustrates an embodiment 600 showing a method for creating a cultural database. The parameters and values are defined for each culture in block 602. Any redundant entries may be consolidated in block 604. For each parameter in block 606, if the parameter is a high use parameter in block 608, it may be added to a high-speed lookup table in block 610. After each parameter is evaluated in block 606, the lookup table may be optimized in block 612. Similarly, each database entry may be indexed for fast lookup in block 614. The data may be compressed in block 616, encrypted in block 618, and saved in block 620.

The embodiment 600 is a method for optimizing the overall performance of the database. Some parameters may be suited for an optimized lookup table, especially parameters that are frequently queried. Other data may be lengthy or infrequently accessed and may be stored in a different manner.

The database can be a human readable format or may be made into a computer readable format, with optional data compression and encryption. In some cases, the data may be created and edited using XML or other human readable format and then compiled into a machine readable format for use by an application. The compilation process may include compression for size reduction and optimization for speed improvement.

For the purposes of this application, the architecture and structure of the database can encompass any known data storage and retrieval method known or developed in the future.

The foregoing description of the invention has been presented for purposes of illustration and description. It is not intended to be exhaustive or to limit the invention to the precise form disclosed, and other modifications and variations may be possible in light of the above teachings. The embodiment was chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments of the invention except insofar as limited by the prior art.

What is claimed is:

1. A method comprising:
identifying at least one functional aspect of a computer program, said functional aspect relating to differences between cultures, said functional aspect having a plurality of parameters;
defining a first set of values for said parameters, said first set of values being related to a first culture;
storing said first set of values in a database, said first set of values being adapted to cause culturally specific functional aspects of a computer program to be executed in accordance with said first culture;
identifying a second culture;
defining a second set of values for said parameters for said second culture, and
storing said second set of values in said database, said second set of values being adapted to cause culturally specific functional aspects of a computer program to be executed in accordance with said second culture.

2. The method of claim 1 wherein said storing said first set of values and said second set of values in said database comprises the method of:
reading raw data;
removing at least one duplicate entry; and
saving said database in a machine readable form.

3. The method of claim 1 wherein said storing said first set of values and said second set of values in said database comprises the method of:
identifying a set of high use parameters, said set being a subset of said plurality of parameters; and
creating a lookup table for only said set of high use parameters.

4. The method of claim 1 wherein said functional aspects comprise text formatting and display parameters for different languages.

5. The method of claim 1 wherein said functional aspects comprise country specific parameters.

6. A computer-readable medium having computer-executable instructions for performing the steps recited in claim 1.

7. A system comprising:
a plurality of functional aspects of computer programs, said functional aspects relating to differences between cultures;
a plurality of parameters describing said plurality of functional aspects;
a first set of values for said parameters, said first set of values being related to a first culture;
a database in which said first set of values are stored;
a computer program adapted to use said first set of values to cause culturally specific functional aspects of a computer program to be executed in accordance with said first culture;
a second set of values for said parameters for a second culture;
a predefined procedure for storing said second set of values in said database so that said second set of values can be used to cause culturally specific functional aspects of said computer program to be executed in accordance with said second culture.

8. The system of claim 7 wherein:
said first set of values and second set of values is in a non-human readable format.

9. The system of claim 7 wherein:
said database comprises said first set of values and said second set of values in a non-human readable format.

10. The system of claim 7 wherein said storing said first set of values and said second set of values in said database comprises the method of:
reading raw data;
removing at least one duplicate entry; and
saving said database in a machine readable form.

11. The system of claim 7 wherein said storing said first set of values and said second set of values in said database comprises the method of:
identifying a set of high use parameters, said set being a subset of said plurality of parameters; and
creating a lookup table for only said set of high use parameters.

12. The system of claim 7 wherein said functional aspects comprise text formatting and display parameters for different languages.

13. The system of claim 7 wherein said functional aspects comprise country specific parameters.

14. A database comprising:
parameters that indicate cultural localization differences, said cultural localization differences being related to functional aspects of an executable program, said database comprising at least two values for at least one parameter wherein each of said at least two values corresponds with different cultural locations;
a query mechanism by which a plurality of executable programs may query said database to receive values for said parameters and execute in a localized manner based on said value; and
a procedure for adding an additional value to said at least one parameter for a new cultural location such that said plurality of executable programs execute in a localized manner based on said additional value.

15. The database of claim 14 wherein:
said values are in a non-human readable format when queried from said database.

16. The database of claim 14 wherein:
said values are in a human readable format when queried from said database.

17. The database of claim 14 wherein said procedure comprises the method of:
reading raw data;
removing at least one duplicate entry; and
saving said database in a machine readable form.

18. The database of claim 14 wherein said procedure comprises the method of:
identifying a set of high use parameters, said set being a subset of said plurality of parameters; and
creating a lookup table for said set of high use parameters.

19. The database of claim 14 wherein said functional aspects comprise text formatting and display parameters for different languages.

20. The database of claim 14 wherein said functional aspects comprise country specific parameters.
